(19) United States
(12) Patent Application Publication
(10) Pub. No.: US 2013/0056035 A1
(43) Pub. Date: Mar. 7, 2013

(54) METHOD AND ARRANGEMENT FOR CLEANING ONE OR MORE AIR FILTERS

(71) Applicant: DAKRA B.V., Elspeet (NL)

(72) Inventor: Dave William Erwin KRAAI, ELSPEET (NL)

(73) Assignee: DAKRA B.V., ELSPEET (NL)

(21) Appl. No.: 13/667,136

(22) Filed: Nov. 2, 2012

Related U.S. Application Data
(63) Continuation of application No. PCT/EP2011/057150, filed on May 4, 2011.
(60) Provisional application No. 61/330,921, filed on May 4, 2010.

(30) Foreign Application Priority Data
May 4, 2010 (NL) 2004664

(51) Int. Cl. B08B 3/02; B08B 3/06; B08B 3/04

(52) U.S. Cl. 134/25.1; 134/33; 134/148; 134/104.4

(57) ABSTRACT

A method of cleaning one or more air filter elements with a cleaning arrangement includes a rotatable basket for holding the one or more air filters, a spraying device for spraying cleaning fluid into the basket, and a driving unit for driving the basket into rotational motion. The method includes placing the one or more air filter elements in the basket, and performing at least three cleaning cycles. A cleaning cycle comprises the following steps. First the rotation of the basket is driven up to a rotational speed at which the one or more air filter elements have a speed greater than about 15 m/s, preferably greater than about 20 m/s. Then the rotation of the basket is brought back to a rotational speed at which the one or more air filter elements have a speed below about 2 m/s. In addition, the cleaning cycle includes spraying cleaning fluid into the basket during at least a portion of the cycle.

### CROSS REFERENCE TO RELATED APPLICATIONS

This application is a continuation of PCT application number PCT/EP2011/057150 filed on 4 May 2011, which claims priority from Netherlands application number NL 2004664 filed on 4 May 2010 and U.S. provisional application No. 61/330,921 filed on 4 May 2010. All applications are hereby incorporated by reference in their entireties.

### BACKGROUND OF THE INVENTION

1. Field of the Invention

The present invention relates to a method and an arrangement for cleaning one or more air filters.

2. Description of the Related Art

Vehicles are provided with air filter units that are removably placed over the air-intake throats of carburetors. For conventional vehicles, like mainstream automobiles and motorcycles, these air filter units are made of paper. Such paper filter unit is relatively easy to make, and its cost prize is low. Therefore, if such filter unit is clogged after an extensive period of use, it will be replaced with a new filter unit, and the old filter unit will be disposed of.

For off-road vehicles like motorcycles used for motocross, enduro-motors, quads, sidecars and the like, the use of such paper air filters is very inconvenient as they will be clogged within an extremely short period of time. Moreover, these paper filter units are vulnerable for exposure to off-road conditions which includes contact with dust, mud and/or grid. Therefore, foam air filters are removably mounted on the air intake throats of engine carburetors or fuel injection systems of off-road vehicles instead. The foam air filter units are provided with air filter oil, and are soiled during use by exposure to sand, dust and mud. The foam air filter units can withstand most off-road conditions, but may, in particular when the off-road conditions are very bad, be clogged within a relatively short period of time as well, for example within a few hours of use. The unit price of a foam air filter unit is relatively high, which makes it worthwhile to clean the filter unit for reuse.

Currently, cleaning of foam air filter units is often done by hand. This cleaning is performed by washing the units with gasoline or another fluid suitable for removal of grease. The filters are then washed with soap to remove the final residue from the foam, and then washed with water. After drying of the filters, the filter units can be provided with air filter oil and are then ready for reuse. Cleaning by hand is time-consuming and may expose the person who cleans to fluids and vapors, e.g. gasoline fumes, that are not healthy. For example, the exposure to such fluid may lead to skin irritation.

The use of cleaning apparatus for cleaning air filter units has been described in old literature, but did not result in commercially viable solutions. For example, U.S. Pat. No. 2,156,594 by Charles Lester describes an air filter cleaning apparatus for washing and cleaning air filter units associated with air intake throats of automobile carbureters. The apparatus comprises a container partially filled with a cleaning fluid. A filter unit is removably secured upon a mounting collar of a drive chuck. When a filter unit has been suitably secured, the filter unit undergoes one or more reciprocatory movements into and out of the cleaner fluid which may be combined with rotary movement while being located within the cleaner fluid. Sediment is collected in a lower portion of the container. The capacity of this cleaning apparatus is limited as it takes time for sediment to reach a quiet zone in the container substantially free of agitation during the movements described above. Consequently, this apparatus is not suitable for cleaning a larger number of air filter units within a limited period of time. Additionally, the quality of cleaning is limited.

U.S. Pat. No. 3,650,283 by David C. Lang describes a cleaning apparatus for filters comprising a tank, a rotatable support means for the filters, and means for continuously supplying cleaning liquid to spray means within the tank and for removing cleaning liquid from the tank. The filters are rotatably driven while being sprayed at a speed between about 12 and 20 rpm. The spraying continues for about 5 to 10 minutes. The cleaning fluid containing dirt is captured in a separate tank and can be reduced after passage of a filter. The quality of cleaning is again limited, and highly depends on the quality of the filter filtering the cleaning fluid that is re-used.

U.S. Pat. No. 2,699,793 describes a centrifugal cleaner for air filters, in particular substantially flat filters. The filters are cleaned using spray pipes while being rotated. The spray pipes may use hot water or solvent. In dependence on the liquid being used a different recovery scheme is used, which makes the design complex. The liquid is provided via a plurality of spray pipes that are spread throughout the cleaner, which results in a complex supply of liquid via a large number of components.

US-patent application 2005/0034601 describes a fluid filter cleaning apparatus designed to clean a filter using a cleaning fluid. The apparatus comprises a filter holder for holding the filter such that when the filter holder rotates, the filter rotates about its central axis. The quality of cleaning is limited, because the rotational speed of a filter segment varies highly in dependence of its position.

Australian patent 520234 describes an apparatus for cleaning a filter element using a solvent in a wash cycle. If the filter is heavily soiled a pre-wash cycle is to be used. The duration of the wash cycle is preset according to the condition of the filter. The dirty solvent is drained from the bottom of a cleaning tank and is cleaned and recycled for further use. The quality of cleaning is again limited, and highly depends on the quality of the recycled solvent.

U.S. Pat. No. 6,428,588 describes a filter cleaning apparatus using air as a cleaning medium in combination with a vacuum pump. The apparatus uses a cleaning cycle, the duration of which can be preset. Alternatively, the cleaning cycle continues until a particle sensor ceases to detect significant levels of fouling in the air leaving the filter to be cleaned. The cleaning ability of this apparatus is limited to the cleaning of filters that may be cleaned with air. Furthermore, waiting until a detector determines that the filter is sufficiently clean makes the duration of the cleaning process highly unpredictable.

### BRIEF SUMMARY OF THE INVENTION

It is an object of the invention to provide a method and arrangement for effectively cleaning air filter units, in particular foam air filter units, without the disadvantages discussed above. For this purpose, the invention relates to a method of cleaning one or more air filter elements with a cleaning arrangement comprising a rotatable basket for holding the one or more air filter elements, a spraying device for spraying cleaning fluid into the basket, and a driving unit for driving the basket into rotational motion, the method comprising: placing the one or more air filter elements in the basket; and performing at least three cleaning cycles; wherein a cleaning cycle comprises: driving the rotation of the basket up to a rotational speed at which the one or more air filter elements have a speed greater than about 15 m/s, preferably greater than about 20 m/s; and bringing back the rotation of the basket to a rotational speed at which the one or more air filter elements have a speed below about 2 m/s; wherein the cleaning cycle further comprises spraying cleaning fluid into the basket during at least a portion of the cycle. This method results in an automatic and improved cleaning of air filter units. The maximum number of revolutions allows for deformation of the air filter elements which opens the pores therein and allows dirt to dissolve in the cleaning fluid and allows other material like sand to be taken along with the cleaning fluid as it moves out of the air filter element due to centripetal forces. Driving up the rotation to such speed may correspond to driving up the speed of the rotation of the basket to a number of revolutions exceeding about 1000 revolutions per minute (rpm).

In an embodiment, the method further comprises, after driving up the rotation of the basket, keeping the rotational speed at substantially the same level for a first period of time. Holding the rotation at this level allows fluid to travel through the air filter elements for effective cleaning and move out of the filter element due to centrifugal forces.

In an embodiment, the method further comprises performing at least one drying cycle, the drying cycle comprising: driving the rotation of the basket up to a rotational speed at which the one or more air filter elements have speed greater than about 15 m/s, preferably greater than about 20 m/s; keeping the rotational speed at substantially the same level for a second period of time; and bringing back the rotation of the basket to zero. The use of one or more drying cycles provide a cleaned air filter unit that is sufficiently dry to be re-used within a short period of time. Preferably, the second period of time is longer than the first period of time. A longer period of maximum revolutions per minute causes more liquid to be removed from the air filter element. As there is no acceleration, cleaning will be less efficient than during the period in which the basket is driven from a low number of revolutions to the maximum number of revolutions. The first and/or second period may be predetermined periods. The use of predetermined periods allows for the use of one or more cleaning programs.

In an embodiment, bringing back the basket rotation is performed by deactivating the driving unit. Deactivation of the driving unit is relatively easy to perform. Alternatively, in an embodiment, bringing back the basket rotation is performed by decoupling a connection between the basket and the driving unit. Both decoupling of the basket and the driving unit and deactivating the driving unit allows the basket to decelerate in a gradual way. Due to the gradual slowdown of rotation, the damage to the air filter elements caused by abrupt forces is minimized, if present at all.

In an embodiment, the number of air filter elements is two or more, and the air filter elements are placed in a substantially symmetric fashion in the basket. Symmetric placement of the air filter elements minimizes skew movement of the basket during rotation.

The rotation of the basket may be driven up to a number of revolutions exceeding about 2500 revolutions per minute. Such number of revolutions per minute provides good results.

The first time period may be in the range from about 3 to about 25 seconds. Experiments have shown that a time period in this range is sufficient to remove cleaning fluid with improved cleaning action. Keeping the rotational speed at the maximum for a longer period of time has an effect on the quantity of fluid that is removed from the air filter elements, but does not necessarily improve the cleaning action.

An embodiment of the invention further relates to a computer readable medium having computer readable instructions stored thereon for performing, when executed by a processor, any embodiment of the method discussed above.

An embodiment of the invention further relates to a cleaning arrangement for cleaning one or more air filter elements comprising: a housing for accommodating a rotatable basket, and a spraying device for spraying cleaning fluid into the basket, wherein the basket has an open-structured side wall being arranged for connection of the one or more air filter elements such that the basket can hold the one or more air filter elements; a driving unit for driving the basket into rotational motion, the driving unit being capable of driving the rotation of the basket up to a rotational speed such that the one or more air filter elements held in the basket can have a speed greater than about 15 m/s, preferably greater than about 20 m/s; and a pump system for supplying cleaning fluid to the spraying device. Acceleration up to higher velocities may result in more deformation of the air filter units and provides improved cleaning.

In an embodiment, the driving unit is programmable to perform any method of cleaning as discussed above. The ability to use different programs allows for tailor-made cleaning. For example, more dirty air filter units may be cleaned with a program comprising more cleaning cycles than average, while less dirty air filter units may be cleaned with a program comprising less cleaning cycles than average.

In an embodiment, the cleaning arrangement further comprises a fluid container for capturing cleaning fluid and for allowing sedimentation of particulate dirt. Such fluid container allows the arrangement to re-use cleaning fluid. Additionally, the container allows for a decent storage of cleaning fluid, which provides a tidy operation of the arrangement. Furthermore, if the cleaning fluid is close to saturation, the fluid can be easily removed from the fluid container. If the fluid container is removably attachable, the container can be cleaned before new cleaning fluid is put into the arrangement. In a further embodiment, the pump system is further arranged for providing the cleaning fluid to the spraying device. Such arrangement of the pump system allows the re-use of cleaning fluid in an automatic way. The pump system may comprise a submersible pump which is placed in the fluid container. The placement of such pump in the container reduces the volume occupied by the cleaning arrangement.

In an embodiment, the basket comprises a wire mesh wall onto which the one or more air filter elements can be mounted. Such wire mesh wall enables easy removal of cleaning fluid due to centrifugal forces and allows for easy attachment of the filter units.

In an embodiment, the spraying device has the form of a tube with one or more holes, and the spraying device is arranged to coincide with the rotation axis of the rotatable basket. Such arrangement of the spraying device allows for an effective coverage so that cleaning fluid is effectively distributed over the air filter elements in the basket during cleaning. In a further embodiment, the basket is rotatable with respect to the spraying device. Such arrangement of basket and spraying device allows for a homogeneous spraying of cleaning fluid into the basket and up to the air filter elements placed therein.

### BRIEF DESCRIPTION OF THE DRAWINGS

The features and advantages of the invention will be appreciated upon reference to the following drawings, in which:

FIG. 1 schematically shows a cleaning arrangement for cleaning one or more air filters according to an embodiment of the invention;

FIG. 2 schematically shows an exploded view of a more detailed embodiment of the cleaning arrangement according to the invention;

FIG. 3 schematically shows an embodiment of a rotatable basket that may be used in the cleaning arrangement of FIG. 2;

FIG. 4 schematically shows an embodiment of a fluid container that may be used in the cleaning arrangement of FIG. 2;

FIG. 5 schematically shows an embodiment of a fluid level indicator device that may be used in embodiments of the invention;

FIG. 6 schematically shows a way to removably mount an air filter element onto a side wall of a basket;

FIGS. 7a, 7b schematically show different ways of supporting the basket within the housing;

FIG. 8 schematically shows a more detailed view of an embodiment of a supporting arrangement between the top portion of the basket and a frame construction connected to the housing;

FIG. 9 schematically shows a cross-sectional view of another more detailed embodiment of the cleaning arrangement;

FIG. 10 schematically shows a three-dimensional view of the cleaning arrangement of FIG. 9; and

FIG. 11 schematically shows a cleaning arrangement similar to the arrangement of FIG. 9 filled with a cleaning fluid.

### DESCRIPTION OF ILLUSTRATIVE EMBODIMENTS

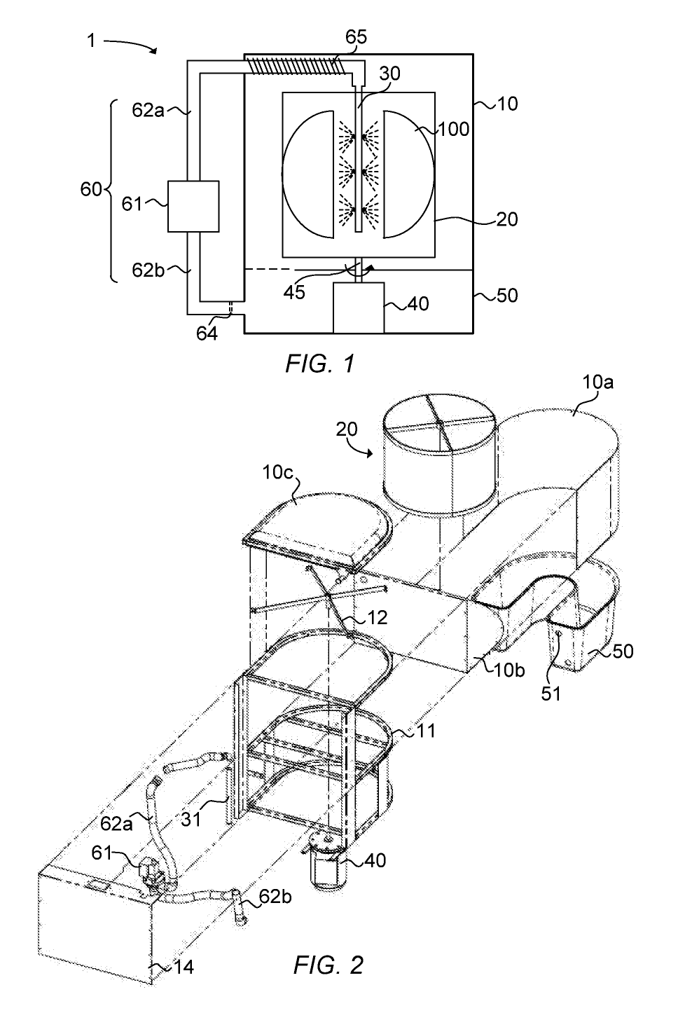

The following is a description of certain embodiments of the invention, given by way of example only and with reference to the drawings. FIG. 1 schematically shows a cleaning arrangement 1 for cleaning one or more air filter elements according to an embodiment of the invention. The cleaning arrangement 1 comprises a housing 10 accommodating a rotatable basket 20 and a spraying device 30.

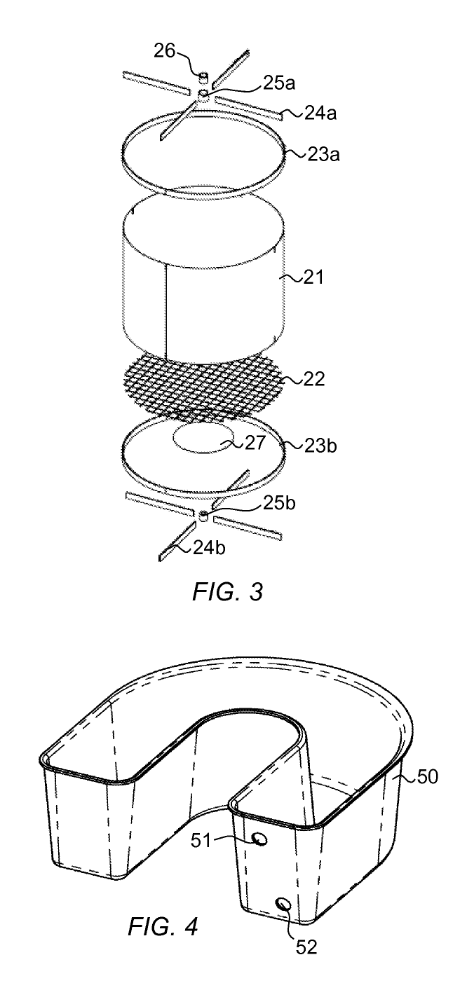

The rotatable basket 20 is arranged for holding one or more air filter elements 100. The rotatable basket 20 is connected to a driving unit 40 for driving the basket into a rotational motion. An embodiment of the rotatable basket will be discussed with reference to FIG. 3.

The spraying device 30 comprises a tube with a plurality of holes and/or nozzles. Preferably the holes are arranged at different positions along the circumference of the tube, as well as at different positions along the length of the tube. The spraying device 30 is positioned in the center of the basket 20, preferably in such a way that the tube axis substantially coincides with the rotation axis of the basket 20. Such position enables the spraying device 30 to spray in a radially outward direction. This allows the cleaning fluid to contact the one or more air filter elements 100 at the inside, and force its way through the filter elements outwards under the influence of centrifugal forces. The coupling between the spraying device 30 and the basket 20 may be such that the basket 20 can rotate with respect to the spraying device 30. Such coupling allows for an more homogeneous distribution of cleaning fluid over the air filter elements 100 in the basket 20.

The driving unit 40 may be an electromotor. The basket 20 may be connected to the driving unit 40 via a shaft 45. The driving unit 40 may be placed within the housing 10, but may also be placed outside the housing 10.

The basic operation of the cleaning arrangement 1 starts with placement of one or more air filter elements 100 in the basket 20. The air filter elements 100 may be connected to the outside wall of the basket 20, for example in a way as discussed with reference to FIG. 6. Preferably, two or more air filter elements 100 are symmetrically distributed with respect to the rotation axis of the basket. A symmetric distribution of the air filter elements reduces skewed movement of the basket, which may improve the operational efficiency of the arrangement 1. Furthermore, the cleaning of the air filter elements 100 may be effectuated in a more predictable way.

After placement of the one or more air filter elements 100, the basket 20 is driven by the driving unit 40 up to a rotational speed at which the one or more air filter elements 100 have a speed greater than about 15 m/s, preferably greater than about 20 m/s. Preferably, the increase of the rotational speed is a gradual increase. Thereafter the rotational speed of the basket is brought back to a level at which the one or more air filter elements 100 have a speed below 2 m/s. Again, the decrease of rotational speed is performed in a gradual way, for example by deactivating the driving unit 40 or by temporarily decoupling the driving unit 40 and the basket 20. Alternatively, the driving unit 40 may comprise or communicate with a brake mechanism to lower the rotational speed of the shaft 45, and therewith the rotational speed of the basket 20 holding the one or more air filter elements 100 as well.

The gradual increase in general takes about 5 seconds or more, preferably about 10 seconds or more, more preferably about 20 seconds or more, generally about 5 minutes or less, preferably about 1 minute or less. The decrease of rotational speed in general takes about 5 minutes or less, preferably about 3 minutes or less, more preferably 2 minutes or less.

In many applications, the maximum rotational speed of the basket corresponds to driving the rotation axis of the basket up to a number of revolutions that exceeds about 1000 revolutions per minute (rpm). In particular embodiments, where the basket 20 is relatively large in size to accommodate a relatively large number of air filter elements 100, the number of revolutions may exceed about 2500 rpm. Similarly, bringing back the rotational speed of the basket may correspond with bringing back the number of revolutions of the rotation axis of the basket 20 to a number of revolutions below 100 rpm.

The cycle of driving up to a maximum rotational speed, and then reducing the rotational speed of the basket 20 back to a minimal level is performed several times. During at least a portion of this cycle, spraying device 30 is arranged to spray cleaning fluid into the basket 20. Spraying of the liquid is most effective if the speed of the air filter elements 100 in the basket 20 is lower than 15 m/s. The air filter elements 100 are then more susceptible to the reception of fluid. At high speeds, the liquid tends to be thrown back by the rotating elements. Thereby, soaking of the air filter may be less effective. However, this depends on the specific device.

Preferably, the spraying of cleaning fluid into the basket 20 is performed within at least a portion of the time during which the rotation of the basket 20 is brought back to a minimal rotational speed. If the cleaning fluid is sprayed during the period of bringing back the rotational speed, in particular a first portion thereof, the cleaning fluid is well absorbed by the air filter elements 100 to be cleaned, and the cleaning fluid may have time to partially leak out of the air filter elements 100. The latter effect may improve the performance of the driving unit 40 in that it operate more economically because less weight has to be driven up to maximum rotational speed in the next cycle.

However, it is equally possible to keep the flow of liquid during the subsequent cycles. Keeping a liquid flow throughout the cycles is easy to operate and can be performed with a driving unit 40 of little complexity.

The cleaning fluid is absorbed by an air filter element 100. Dirt present in the filter element 100 then dissolves in the cleaning fluid. Thereby, clogging particles like sand and dust become free from the filter element 100. If the speed of the air filter elements 100 exceeds a certain threshold value, typically about 15 m/s, the cleaning fluid with dirt dissolved therein is forced to leave the filter element 100 due to the centripetal forces. On its way out, the cleaning fluid may further pick up other clogging elements, like sand.

Performing a method of cleaning air filter elements with the cleaning arrangement 1 in the way as described above allows for an automatic and improved cleaning of air filter elements 100. The driving of the rotation speed up to a speed at which the one or more air filter elements 100 have a speed greater than about 15 m/s will cause the air filter elements 100 to deform. In particular if the air filter elements 100 are foam air filter elements, pores of the foam structure are deformed in response to the acceleration. Different parts of the foam structure will become available for the cleaning fluid, and the cleaning fluid may then more easily enter all parts of the filter elements 100 and remove dirt, sand and the like. The cleaning fluid may thus be used more effectively, which results in the need of less cleaning fluid and shorter cleaning time. Furthermore, the cleaning fluid may clean portions of the air filter elements 100 that are normally not addressed during cleaning at low speed only.

Furthermore, if the acceleration towards a maximum rotational speed is substantially constant and moderate in size, abrupt deformation of a filter element 100 is minimized, which can extend the lifetime of a filter element 100 in comparison to a filter element that is cleaned manually.

Preferably, the maximum rotational speed that is reached may be maintained for a preferably short period of time, for example 3 seconds or more, more preferably 5 seconds or more. During this time cleaning fluid is allowed to exit the air filter elements 100 in a relatively easy manner. The period generally will be about 60 seconds or less, preferably 25 seconds or less. The period can be longer, like for example a few minutes, but no substantial improvement has been found.

A cycle as described above is referred to as a cleaning cycle. In embodiments of the invention, three or more cleaning cycles are performed. It has been found that using three cleaning cycles or more provides a substantially better cleaning result than the mere use of one or two cleaning cycles. Although the minimum number of cleaning cycles to obtain improved cleaning of air filter elements is preferably set to equal three, the use of more cleaning cycles may be desirable. In particular if the cleaning fluid has already been re-used several times, more cleaning cycles may be needed to obtain desirable results. Additionally, the optimal number of cleaning cycles is dependent on the desired cleaning performance and the available time. Generally, the use of an additional cleaning cycle results in a better cleaned air filter element. However, less improvement is expected per additional cleaning cycle. Preferably, an optimum cleaning program may be programmable based on the desirable minimum level of cleaning and the available time.

To accelerate the process of drying of cleaned air filter elements 100, the cleaning arrangement may further be arranged to perform at least one “drying cycle”. In a drying cycle, the rotation of the basket 20 is first driven up to a rotational speed at which the one or more air filter elements 100 have a speed greater than about 15 m/s, preferably greater than about 20 m/s. As discussed earlier, such speeds may correspond to a number of revolutions of the rotation axis connected to the basket 20 that exceeds about 1000 revolutions per minute. Then the high rotational speed of the basket 20 is kept at substantially the same level for a second period of time, and finally the rotation of the basket is brought back to zero. During the drying cycle, the spraying device is not in use. Because rotation at high rotational velocity improves the removal of liquid from the air filter element, the second period of time is preferably greater than the first period of time. The first period of time is preferably in the range from about 3 seconds to about 25 seconds, but may be longer, e.g. about 1 minute. The second period of time is preferably in the range from about 25 seconds to about 90 seconds, but may be longer as well, e.g. about 5 minutes. Preferably, the first and/or the second period of time is a predetermined period, and more preferable programmed into the device.

The cleaning fluid may be a cleaning fluid already used for manual cleaning operations. Examples include gasoline, and commercially available cleaners like Protect Cleaner sold by BO Motor Oil, Steenfortse weg 2b, 5091 BS Middelbeers, the Netherlands. Alternatively, the cleaning fluid to be used in the cleaning arrangement 1 may be a biodegradable fluid, for example Protect Cleaner BIO sold by BO Motor Oil, Steenfortse weg 2b, 5091 BS Middelbeers, the Netherlands.

The examples of cleaning fluids mentioned above are reusable cleaning fluids. These cleaning fluids are generally non-aqueous. Alternatively, non-reusable, aqueous cleaning fluids may be used. These aqueous cleaning fluids are generally most effective if they are heated to an elevated temperature, typically about 60-70° C., although recently fluids that operate at a lower temperature have been developed.

The cleaning arrangement 1 further comprises a fluid container 50. The container 50 may be removable from the housing 10. Alternatively, the fluid container 50 forms an integral part of the housing 10. The fluid container 50 is arranged for capturing cleaning fluid sprayed by the spraying device 30. Furthermore, the container 50 is preferably arranged to enable the sedimentation of dirt, e.g. sand, clay and/or dust. The fluid container 50 may be arranged to accommodate a certain amount of cleaning fluid, e.g. about 20 l. An embodiment of the fluid container 50 will be discussed with reference to FIGS. 2 and 4.

The cleaning arrangement 1 further comprises a pump system 60. The pump system 60 is arranged for pumping cleaning fluid up from the fluid container 50 and for providing the cleaning fluid to the spraying device 30. The pump system 60 allows the reuse of cleaning fluid. The reuse of fluid reduces the costs of air filter element cleaning because less cleaning fluid is needed to clean a number of filter elements 100. Furthermore, the reuse of fluid reduces the ecological footprint of the cleaning arrangement 1, in particular if a non-biological cleaning fluid is used.

The pump system 60 comprises a pump 61. The pump system 60 further comprises one or more connection elements 62a for connecting the pump 61 with the fluid container 50. Similarly, the pump system 60 comprises one or more connection elements 62b for connecting the pump 61 with the spraying device 30. The connection elements 62a, 62b may comprise tubes. Preferably, the connection elements 62a, 62b are made of a material that can cope with the cleaning fluid over a long period of time. Suitable materials include, but are not limited to, polyvinylchloride (PVC), polypropylene (PP) and acrylonitrile butadiene styrene (ABS). To avoid the transfer of dirt from the container 50 towards the spraying device 30, the pump system 60 may be provided with a filter 64. The pump system 60 may further comprise a temperature conditioning device, e.g. a heating coil 65, to bring the cleaning fluid to an effective temperature for cleaning.

The connection of the pump system 60 with the fluid container 50 is preferably at a height below the minimally desirable fluid level in the fluid container 50 to ensure efficient pumping. The pump 61 may be positioned outside of the container 50 as shown in FIG. 1. Alternatively, the pump 61 may be submersible pump that can be placed in the container 50.

FIG. 2 schematically shows an exploded view of a more detailed embodiment of the cleaning arrangement according to the invention. The housing is formed by sidewall elements 10a, 10b, and lid 10c. The entire structure is preferably strengthened by a frame 11 which may comprise one or more strengthening elements like a spoke construction 12. The use of the frame 11 improves the structural integrity of the cleaning arrangement. The frame may be made of steel. The use of a housing provides a closed system. As a result, fumes of the cleaning fluid can be kept within the housing, which reduces health related risks like the risk of skin irritation.

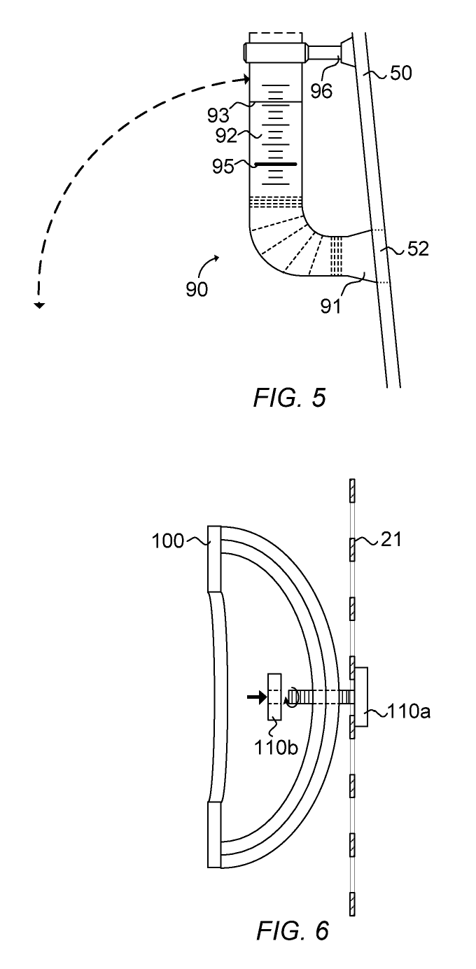

The rotatable basket 20 may take the form of a cylinder provided with an open-structured wall. The basket 20 may comprise a wire mesh wall onto which one or more air filter elements 100 can be removably mounted, for example in a way as demonstrated in FIGS. 5a, 5b. Alternatively, the basket 20 may comprise perforated plate with open passage as wall.

The basket 20 may also be strengthened, in particular at its top end, for example via one or more spoke constructions. The forces induced on the basket 20 by the rotation induced by the driving unit 40 will provide a force in a radially outward direction. In particular at the topside of the basket 20 the moment will be relatively large, and further strengthening via a construction like a spoke construction may be needed to improve the structural integrity of the basket 20.

The basket 20 may further comprise a bottom made of a wire mesh material as well. The mesh in the wire mesh wall, and optionally bottom, of the basket 20 may be a regular square mesh structure, for example a mesh with a square pattern having a rib thickness of about 2 mm and openings with a size of about 20 mm by 20 mm. Alternatively, the basket 20 may comprise a wall provided with a plurality of apertures. Further details with respect to the basket 20 will be discussed with reference to FIG. 3.

The spraying device comprises a tube 31 with holes (not shown). The holes may be spread in a evenly manner along the tube 31. Preferably the length of the tube 31 is substantially equal to the height of the basket 20 to allow the cleaning fluid to be spread throughout the entire basket 20. Alternatively, instead of plain through holes, one or more nozzles may be used to create a divergent spray of cleaning fluid. The use of one or more nozzles allows for less apertures in the tube, which may improve pressure conditions in the tube 31.

The driving unit 40 preferably is an electromotor. The electromotor is connected directly to a shaft 45 that is capable of driving the basket into a rotational motion. The driving unit 40 is capable of driving the rotation of the basket 20 up to a rotational speed at which one or more air filter elements 100 placed in the basket 20 have a speed greater than about 15 m/s, preferably greater than about 20 m/s. In many applications this means that the driving unit 40 is capable of driving the rotation axis up to a number of revolutions that exceeds about 1000 revolutions per minute (rpm). In particular embodiments, the number of revolutions may exceed about 2500 rpm. At these rotational speeds, cleaning liquid that is present in the air filter elements to be cleaned will be effectively removed. The driving unit 40 can be for example a programmable driving unit 40 or a non-programmable driving unit. In particular in the latter case, the driving unit is preferably communicatively connectable to a control unit. The control unit preferably is arranged to control the driving unit 40 to execute a method of cleaning air filter elements.

In the shown embodiment, the fluid container 50 takes the form of a horseshoe-shaped container. The container 50 may be partly covered to allow cleaning fluid sprayed by the spraying device and captured by the side walls 10a, 10b to be guided into the container 50 at one end 50a of the horseshoe (left side in FIG. 2). The other end 50b of the horseshoe (right side in FIG. 2) is provided with a first hole 51 for connection to a the pump system 60. Due to the horseshoe shape of the container 50 the cleaning fluid thus flows from the end of entry 50a towards the end of removal 50b along a relatively long path. As a result, the flow between the two ends 50a, 50b is non-turbulent, which allows for efficient sedimentation of particulate dirt material. The cleaning fluid that is pumped up at the end 50b is thus relatively clean, and the cleaning fluid may be recycled more often than would be the case if the flow path between the two ends would be relatively short, i.e. in case a direct flow connection is present. Further details of the container 50 will be discussed with reference to FIG. 4.

Alternative shapes for the fluid container 50 are equally possible. For example, the container may have a rectangular or elliptical shape.

In the shown embodiments, the pump 61 and tubes 62 of the pumping system are arranged outside the housing accommodating the basket 20. The tube 62a is transferred through side wall 10b. To protect the pump system 60 from outside influences, the arrangement is provided with a pump cover 14 arranged for attachment to the frame 70. Alternatively, the pump may be a submersible pump placed in the fluid container 50.

FIG. 3 schematically shows an embodiment of a rotatable basket 20 that may be used in the cleaning arrangement 1 of FIG. 2. The basket 20 comprises a cylindrically shaped wire mesh wall 21 (mesh structure not shown) onto which one or more air filter elements 100 can be removably mounted. The basket further comprises a wire mesh bottom 22 that is connected to the wall 21, for example by means of welding. The basket is strengthened by two support rings 23a, 23b, both provided with spokes 24a, 24b. In the centre of the spoke pattern, connection elements 25a, 25b, 26 may be provided for connection to outside elements. The connection elements may be suitable for a fixed connection, e.g. connection elements 25a, 25b may be arranged for a connection with a shaft driven by the driving unit. A connection element may also be suitable for a connection which allows for further movement with respect to the outside element to which it is connected. For example, connection element 26 may be a bearing-type element which is arranged for connection with the spraying device. As a result of this connection the orientation of the spraying device may remain fixed, while the basket 20 is rotated in response to the driving action of the driving unit. A further example of a bearing suitable for use will be discussed with reference to FIG. 8.

As shown in FIG. 3, the rotatable basket 20 may further comprise a driving unit protection plate 27, for example attached to the spokes 24b in the basket bottom for covering the driving unit. The plate 27 avoids leakage of cleaning fluid to the driving unit. Leakage of cleaning fluid on an unprotected driving unit could lead to malfunctioning of the driving unit.

FIG. 4 schematically shows an embodiment of a fluid container 50 that may be used in the cleaning arrangement 1 of FIG. 2. The fluid container 50 has a horseshoe shape for the reasons discussed with reference to FIG. 2. As also discussed above, one end of the horseshoe is provided with a first hole 51 for connection to a the pump system. This connection may be of a quick release type to allow for easy release, for example if the fluid container 50 is detached for the removal of sedimented dirt.

The fluid container 50 may further be provided with a second hole 52. The second hole 52 may be arranged for removal of cleaning fluid from the cleaning arrangement. Alternatively, the second hole 52 may be arranged for connection to a fluid level indicator device for indicating the fluid level of the cleaning fluid in the container 50.

FIG. 5 schematically shows an embodiment of a fluid level indicator device that may be used in embodiments of the invention. The fluid level indicator device comprises a tube-like structure 90 with a bend. At least the upright portion of the tube is transparent and provided with a scale 92. The structure is removably connected with the content of the container 50 via hole 52. The removable connection may be established via a quick-release coupling 91.

After connection to the container 50, fluid will enter the tube of the fluid level indicator device 90 until the fluid level within the fluid level indicator device is equal to the level within the container 50. A user may thus recognize the fluid level in the container 50, by checking the fluid level 93 in the fluid level indicator device.

If the cleaning fluid level in the container 50 drops below a predetermined threshold value, e.g. level 95 in FIG. 5, a user can thus recognize such level by reading of the scale 92 and take appropriate measures, e.g. add cleaning fluid to the cleaning arrangement. The predetermined threshold value may correspond to the height of the first hole 51. If the fluid level is below the first hole, the pump 61 will not be able to pump up cleaning fluid. As a result, a cleaning cycle cannot be performed anymore.

Instead of, or in addition to, having a function of a fluid level indicator, the tube-like structure 90 may be used to remove cleaning fluid from the container 50. The upper end of the tube-like structure 90 may be removably connected with the container 50, for example via a tube accommodation unit 96 like a yoke having a suitable diameter and shape. Additionally, the tube-like structure 90 is sufficiently flexible to allow lowering of the upper end of the structure 90 below hole 52 (e.g. see arrow). If the quality of the cleaning fluid is considerably reduced, the upper end of the tube-like structure 90 is released from the tube accommodation unit 96 and lowered such that cleaning fluid can flow out of the container 50. The tube-like structure thus provides an easy way to remove cleaning fluid, e.g. before the container 50 is detached for further cleaning, i.e. removal of settled dirt and the like.

FIG. 6 schematically shows a way to removably mount an air filter element 100 onto the side wall 21 of the basket. Air filter elements 100 are generally provided with a center hole 101 used for installment of the filter element on the vehicle. The center hole 101 may be used for mounting the air filter element 100 onto the basket side wall 21 by guiding a suitable connection element therethrough. In FIG. 6, the connection element comprises two parts 110a, 110b. A portion of the first part 110a is placed at the outside of the side wall 21, while another portion extends through the side wall 21 and the center hole 101 of the air filter element. The end of the extending portion is suitable for reception of the second part 110b of the connection element. The connection element may comprise a bolt and a nut. The term “bolt” means any cylindrical screw with a head, where the extended portion has a threaded portion for receiving a complementary part and an unthreaded portion between the threaded portion and the head. The complementary part is covered by the term “nut”. The bolt head may have any shape, but needs to be of a size that allows fixation to the side wall 21 if the nut is in place.

Instead of a bolt and a nut, different element may be used, for example using a hook or the like. The connection element may comprise two parts, but may also be implemented into a single element.

Due to the connection of the one or more air filter elements 100 onto the basket side wall 21 the filter elements are at a maximum distance away from the rotation axis. Consequently, the filter elements will experience a higher velocity as compared to a location closer to the rotational axis at the same number of revolutions. The location of the one or more filter elements 100 in the basket 20 thus enhances deformation of the filter elements 100, which leads to improved cleaning because the cleaning fluid can reach more locations within the filter elements, and may clean the filter elements along more different paths. For air filter elements of type KTM Twin Air, Yamaha, Suzuki, Honda and Kawasaki good results were obtained at speeds between 15 m/s and 40 m/s.

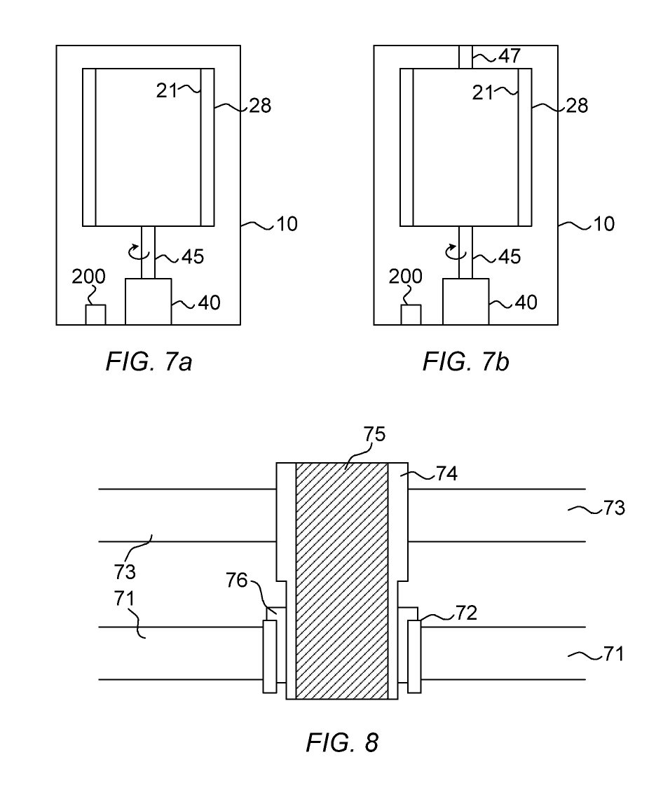

FIGS. 7a, 7b schematically show different ways of supporting the basket 20 within the housing 10. In both FIGS. 7a, 7b, the driving unit 40 is arranged for driving the basket 20. via the driving shaft 45. The basket 20 may thus be supported by the driving shaft 45. In FIG. 7a, support is merely provided by the driving shaft 45. Such construction is relatively easy to manufacture, and allows for an easy construction to position the spraying device 30 within the interior of the basket 20.

In FIG. 7b, further support is given by support element 47. Support element 47 may be connected to the basket 20 via a bearing (not shown). The support element 47 provides additional support, which may reduce precession effects, like skew motion of the basket, during rotation of the basket 20. Such precession effects may reduce the accuracy of spraying, and may reduce the cleaning performance of the arrangement.

Note that in FIGS. 7a, 7b, the cleaning fluid is not captured by the side walls, but by a rotatable housing 28, circumscribing the basket 20, for example with a cylindrical shape. The rotatable housing 28 can be rotationally driven by driving unit 40 via the shaft 45. The bottom of the housing 28 and the basket 20 are integrated into a single bottom.

The embodiment shown in FIGS. 7a, 7b further shows a control unit 200 communicatively connected to a the driving unit 40. The control unit 200 may be arranged to control the driving unit 40 to execute an embodiment of a method of cleaning air filter elements as described earlier.

The control unit 200 as shown in FIG. 7a, 7b, or the driving unit 40, if it is a programmable driving unit, may be implemented as a computer system comprising a processor connected to one or more memory units. The computer system may further comprise one or more input devices, like knobs, a touch screen, a keyboard, a mouse, etc. Some embodiments of a method of processing a service request may be stored on a computer readable medium in the form of computer-readable instructions, for example in the form of a computer program product. The computer readable instructions on the computer readable medium may then be loaded onto the control unit 200 or the programmable driving unit 40. The instructions may be stored in the one or more memory units. Then the processor may execute the instructions obtained from the computer readable medium to perform embodiments of the method of cleaning air filter elements.

FIG. 8 schematically shows a more detailed view of an embodiment of a supporting arrangement between the top portion of the basket 20 and a frame construction connected to the housing. In this embodiment, the top portion of the basket is strengthened by means of spokes 71 connected, for example by means of welding, to a hollow centered ring 72 in a radially outward direction. The frame construction comprises one or more spokes 73 connected, for example by means of welding, to a hollow centered tube 74 in a radially outward direction.

The tube 74 has a diameter that is smaller than the diameter of the ring 72. The tube 74 is further arranged to extend through at least a portion of the ring 72. The hollow space (hatched portion 75 in FIG. 8) within tube 74 is suitable for accommodating a top portion of the spraying device.

The tube 74 and the ring 72 are connected via a sliding contact bearing 76. The presence of bearing 76 allows the ring 72 and spokes 71 to rotate, while the orientation of the tube 74 remains fixed. In this embodiment, he tube of the spraying device (not shown) extending through the tube does thus not rotate as well.

It must be understood that instead of the embodiment shown in FIG. 8 different arrangements may be provided to accomplish a similar effect. For example, instead of a sliding contact bearing 76 a different type of bearing may be used to enable connection between the basket and the frame, while allowing the basket to rotate while the frame remains still.

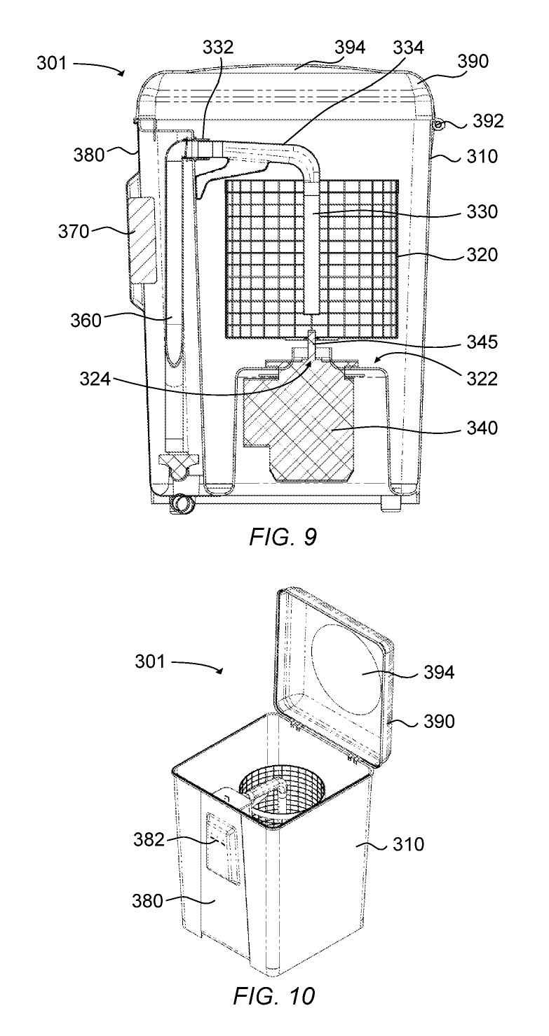

FIG. 9 schematically shows a different cross-sectional view of a cleaning arrangement 301. This arrangement 301 is an integrated design comprising a housing 310 for accommodating a rotatable basket 320 and a spraying device 330. The basket 320 and the spraying device 330 may be similar to the basket 20 and spraying device 30 described with reference to FIG. 1, and will not be described in detail. The housing comprises a bottom with a central elevated portion 322. The central elevated portion 322 is provided with a hole 324. Underneath the elevated portion, a driving unit 340 is provided which is connected to the basket 320 via a shaft 345 which extends through the hole in the bottom of the housing 310. The driving unit 340, e.g. an electromotor, is arranged for rotationally driving the basket 320 via the shaft 345. The housing 310 further includes an opening 332 for enabling the supply of fluid, e.g. cleaning fluid, to the spraying device 330, for example by using a suitable tube construction 334.

The housing 310 may be shaped in such a way that it includes a recession that may be used to accommodate additional components at the outside of the housing 310. Additional components that may be placed in such recession include a pump system 360 and control electronics 370. The control electronics 370 may include an interface to enable programming of the cleaning arrangement 301. Placement of these components outside the housing 310 has the advantage that there is no contact between the dirt that is removed from the filters and these components. Preferably, the recession can be covered by a cover unit, such as a cover plate 380. The cover plate 380 protects the components within the recession from external influences, which can enhance the reliability and durability of the cleaning arrangement even further.

The housing 310 is preferably covered by a lid 390. The lid 390 protects the inside of the housing from external influences. The lid 390 may be opened using a hinge 392, a concept which will be understood by a person skilled in the art. The lid 390 may be provided with a transparent portion 394 which enables a user of the cleaning arrangement 301 to visually check the progression of the cleaning process.

FIG. 10 schematically shows a three-dimensional view of the cleaning arrangement of FIG. 9, where the cleaning arrangement includes a cover plate 380 and a lid 390 with a window 394. The cover plate 380 is provided with one or more input keys or buttons 382 that enable a user to select a suitable cleaning program. In addition, the cover plate 380 may include a display for displaying one or more of cleaning program options, the selected program, and the progress of the cleaning program. The compact design of the cleaning arrangement 301 facilitates easy transportation.

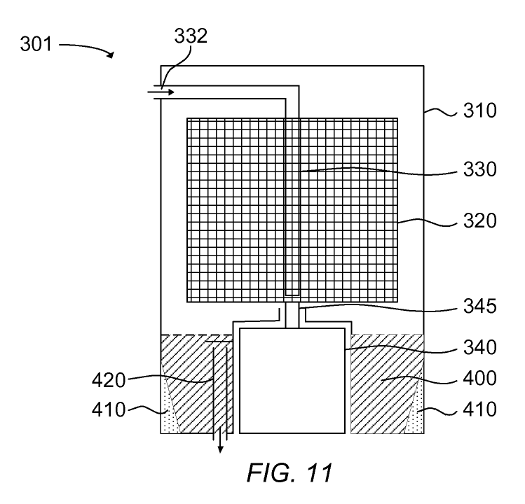

FIG. 11 shows a schematic cross-sectional view of the cleaning arrangement of FIG. 9 filled with a cleaning fluid. In particular, FIG. 11 shows the cleaning arrangement after execution of one or more cleaning cycles. In this cleaning arrangement the reservoir forms an integral part of the housing 310. Cleaning fluid being sprayed by the spraying device 330 is captured in the lower part of the housing 310 which circumvents the driving unit 340. The portion of the housing 310 reserved for the capture and/or storage of cleaning fluid corresponds to the dashed portion 400 in FIG. 11.

For example in a way as described earlier, the cleaning fluid is sprayed into the basket 320 during at least a portion of a cleaning enables removal of dirt from the one or more filters in the basket 320, and is then spun outwards together with the dirt. The cleaning fluid and the dirt then together hit the inner walls of the housing 310 and move downwards towards the reservoir under the influence of gravitational forces. This way of removal may enable the sedimentation and/or agglomeration of dirt, e.g. sand, clay and/or dust, on the bottom of the housing 310, in particular at the outer edge of the portion of the housing reserved for the cleaning fluid. in FIG. 11 the area at which sediments of dirt typically form is schematically denoted by the dotted triangles 410.

The housing may be provided with an overflow spillway 420 for removing cleaning fluid if the fluid level in the housing 310 exceeds a certain predetermined value. Preferably, as shown in FIG. 11, the spillway 420 is located close to the central elevated portion so as to keep away from the area where dirt sedimentation takes place. The fluid that is removed via the spillway 420 may be recycled using a pump system, such as pump system 360, and provided to the spraying device 330 via opening 332. The fluid flow in and out of the housing 310 is schematically shown by means of the arrows.

### EXAMPLE 1

Two air filter elements of type KTM Twin Air are placed opposite of each other in a basket with a diameter of about 22 cm. The cleaning arrangement is filled with 20 liters of cleaning fluid. The pump is arranged to pump about 700 liters/hr. The pump operates with a pressure difference below 1.5 bar. The filters undergo 6-8 cleaning cycles comprising the following steps:
driving the rotation of the basket from 0 up to a maximum rotation level of about 2800 rpm within about 15 seconds. At this maximum rotation level the outermost parts of the two air filter elements move with a speed of about 32 m/s. The drive unit is active.
keeping the rotation at the maximum rotation level during about 5 seconds. The drive unit is active.
bringing back the rotation of the basket to 0 rpm. The drive unit is inactive. In the set-up used, the basket stopped rotating in about 90 seconds after deactivation of the drive unit.

In some experiments, spraying is performed throughout the cleaning cycle. If programming of different spray regimes is possible, during the cleaning cycle, the cleaning fluid is preferably sprayed while bringing back the rotation of the basket to 0 rpm. Furthermore, spraying may be stopped if the rotational velocity of the axis arrives at a lower threshold value to allow cleaning fluid to drip out of the basket before a next cycle is started.

After the 6-8 cleaning cycles, the air filter elements undergo a drying cycle. During the drying cycle, no spraying occurs. The drying cycle comprises the following steps:
driving the rotation of the basket from 0 up to a about 2800 rpm within about 15 seconds. The drive unit is active.
keeping the rotation at about 2800 rpm during about 30 seconds. The drive unit is active.
bringing back the rotation of the basket to 0 rpm. The drive unit is inactive. In the set-up used, the basket stopped rotating in about 90 seconds after deactivation of the drive unit.

### EXAMPLE 2

The cleaning arrangement is similar to the one presented in Example 1 with the exception that the basket has a diameter of about 39.6 cm. The increase in size allows the basket to accommodate four filters instead of two filters.

The filters undergo 6-8 cleaning cycles comprising the following steps:
driving the rotation of the basket from 0 up to a maximum rotation level of about 1400 revolutions per minute within about 5-10 seconds. At this maximum rotation level the outermost parts of the four air filter elements move with a speed of about 29 m/s. The drive unit is active.
keeping the rotation at this maximum rotation level during about 10 seconds. The drive unit is active.
bringing back the rotation of the basket to 0 rpm. The drive unit is inactive. In the set-up used, the basket stopped rotating in about 90 seconds after deactivation of the drive unit.

In some experiments, spraying is performed throughout the cleaning cycle. If programming of different spray regimes is possible, during the cleaning cycle, the cleaning fluid is preferably sprayed while bringing back the rotation of the basket to 0 rpm. Furthermore, spraying may be stopped if the rotational velocity of the axis arrives at a lower threshold value to allow cleaning fluid to drip out of the basket before a next cycle is started.

After the series of cleaning cycles the air filter elements are subject to a drying cycle with specifications that are similar to the one described in Example 1.

### EXAMPLE 3

The cleaning arrangement is similar to the one presented in Example 1 with the exception that the basket has a diameter of about 26 cm. The increase in size allows the basket to accommodate two filters of larger size. The filters undergo 6-8 cleaning cycles comprising the following steps:
driving the rotation of the basket from 0 up to a maximum rotation level of about 2800 rpm within about 15 seconds. At this maximum rotation level the outermost parts of the two air filter elements move with a speed of about 38 m/s. The drive unit is active.
keeping the rotation at the maximum rotation level during about 5 seconds. The drive unit is active.
bringing back the rotation of the basket to 0 rpm. The drive unit is inactive. In the set-up used, the basket stopped rotating in about 90 seconds after deactivation of the drive unit.

In some experiments, spraying is performed throughout the cleaning cycle. If programming of different spray regimes is possible, during the cleaning cycle, the cleaning fluid is preferably sprayed while bringing back the rotation of the basket to 0 rpm. Furthermore, spraying may be stopped if the rotational velocity of the axis arrives at a lower threshold value to allow cleaning fluid to drip out of the basket before a next cycle is started. After the series of cleaning cycles the air filter elements are subject to a drying cycle with specifications that are similar to the one described in Example 1.

Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A method of cleaning one or more air filter elements with a cleaning arrangement comprising a rotatable basket, a spraying device, and a driving unit, the method comprising:
placing the one or more air filter elements in the basket; and
performing at least three cleaning cycles;
wherein a cleaning cycle comprises:
driving the basket via the driving unit into rotation up to a rotational speed at which the one or more air filter elements in the basket have a speed greater than about 15 m/s; and
bringing back the rotation of the basket to a rotational speed at which the one or more air filter elements have a speed below about 2 m/s;
wherein the cleaning cycle further comprises spraying cleaning fluid into the basket via the spraying device during at least a portion of the cycle.

2. The method of claim 1, further comprising, before performing the cleaning cycles, mounting the one or more air filter elements onto one or more side walls of the basket.

3. The method of claim 1, wherein the method, after driving up the rotation of the basket, further comprises keeping the rotational speed at substantially the same level for a first period of time.

4. The method of claim 1, wherein the rotation of the basket is driven up to a number of revolutions exceeding about 1000 revolutions per minute.

5. The method of claim 1, wherein spraying cleaning fluid into the basket is performed within at least a portion of the time during which the rotation of the basket is brought back.

6. The method of claim 1, wherein the method further comprises performing at least one drying cycle, the drying cycle comprising:
driving the rotation of the basket up to a rotational speed at which the one or more air filter elements in the basket have a speed greater than about 15 m/s;
keeping the rotational speed at substantially the same level for a second period of time; and
bringing back the rotation of the basket to zero.

7. The method of claim 6, wherein the rotation of the basket is driven up to a number of revolutions exceeding about 1000 revolutions per minute.

8. The method of claim 6, wherein the second period of time is longer than the first period of time.

9. The method of claim 6, wherein the first and/or second period are predetermined period.

10. The method of claim 1, wherein bringing back the basket rotation is performed by deactivating the driving unit.

11. The method of claim 1, wherein bringing back the basket rotation is performed by decoupling a connection between the basket and the driving unit.

12. The method of claim 1, wherein the number of air filter elements is two or more, and the air filter elements are placed in a substantially symmetric fashion in the basket.

13. The method of claim 1, wherein the rotation of the basket is driven up to a number of revolutions exceeding about 2500 revolutions per minute.

14. The method of claim 1, wherein the first time period is in the range from about 3 seconds to about 1 minute.

15. A computer readable medium containing program instructions for cleaning one or more air filter elements with the cleaning arrangement according to claim 1, wherein the driving unit is a programmable driving unit, and wherein the computer readable medium containing program instructions may be loaded onto the programmable driving unit, and is configured control the driving unit to perform the method of claim 1.

16. A cleaning arrangement for cleaning one or more air filter elements comprising:
a housing for accommodating a rotatable basket, and a spraying device for spraying cleaning fluid into the basket, wherein the basket has an open-structured side wall arranged for connection of the one or more air filter elements such that the basket can hold the one or more air filter elements;
a driving unit for driving the basket into rotational motion, the driving unit being capable of driving the rotation of the basket up to a rotational speed such that the outer portion of the basket can have a speed greater than about 15 m/s; and
a pump system for supplying cleaning fluid to the spraying device.

17. The cleaning arrangement of claim 16, wherein the driving unit is programmable to perform a method of cleaning comprising:
placing the one or more air filter elements in the basket; and
performing at least three cleaning cycles;
wherein a cleaning cycle comprises:
driving the basket via the driving unit into rotation up to a rotational speed at which the one or more air filter elements in the basket have a speed greater than about 15 m/s; and
bringing back the rotation of the basket to a rotational speed at which the one or more air filter elements have a speed below about 2 m/s;
wherein the cleaning cycle further comprises spraying cleaning fluid into the basket via the spraying device during at least a portion of the cycle.

18. The cleaning arrangement of claim 16, further comprising a fluid container for capturing cleaning fluid and for allowing sedimentation of particulate dirt.

19. The cleaning arrangement of claim 18, wherein the pump system is further arranged for pumping cleaning fluid up from the fluid container and for transferring the pumped up cleaning fluid to the spraying device.

20. The cleaning arrangement of claim 16, wherein the basket comprises a wire mesh wall onto which the one or more air filter elements can be mounted.

21. The cleaning arrangement of claim 16, wherein the spraying device has the form of a tube with one or more holes, and the spraying device is arranged to coincide with the rotation axis of the rotatable basket.

22. The cleaning arrangement of claim 21, wherein the basket is rotatable with respect to the spraying device.

23. A method of cleaning one or more air filter elements with a cleaning arrangement comprising a rotatable basket, a spraying device, and a driving unit, the method comprising:
placing the one or more air filter elements in the basket; and
performing at least three cleaning cycles;
wherein a cleaning cycle comprises:
driving the basket into rotational motion via the driving unit up to a number of revolutions exceeding about 1000 revolutions per minute; and
bringing back the rotation of the basket to a number of revolutions below about 100 revolutions per minute;
wherein the cleaning cycle further comprises spraying cleaning fluid via the spraying device into the basket during at least a portion of the cycle.
